(19) United States
(12) Patent Application Publication
(10) Pub. No.: US 2011/0250386 A1
(43) Pub. Date: Oct. 13, 2011

(54) Highly Durable Composite Radiant Barrier

(75) Inventor: Dennis M. Gonsior, Mandeville, LA (US)

(73) Assignee: LIO ENERGY, LLC, Covington, LA (US)

(21) Appl. No.: 13/082,145

(22) Filed: Apr. 7, 2011

Related U.S. Application Data
(60) Provisional application No. 61/322,972, filed on Apr. 12, 2010.

(51) Int. Cl. B32B 3/10; B32B 38/04; B32B 27/12

(52) U.S. Cl. 428/131; 442/286; 156/253

(57) ABSTRACT

A highly durable composite radiant bather for inhibiting radiant heat transfer is disclosed. Such a radiant barrier includes a core material including a mixture of expanded polyethylene foam and a fire retardant material. A layer of a mixture of low density polyethylene and a fire retardant material may be applied to each side of the core material. A highly reflective material, such as polished aluminum foil, is affixed to one side of the core material. A woven polyethylene material having an aesthetically pleasing color and texture is affixed to the opposite side of the core material.

### CROSS REFERENCE TO RELATED APPLICATION

This application claims the benefit of U.S. Provisional Patent Application Ser. No. 61/322,972 filed on Apr. 12, 2010 which is expressly incorporated herein in its entirety by reference thereto.

### FIELD

The present invention relates generally to the field of radiant barriers.

### BACKGROUND

Thermal energy, or heat, may be transferred by a number of different processes, including conduction, convection, and thermal radiation. All materials emit a certain amount of thermal radiation as a function of surface temperature and a given material's emissivity. Emissivity, which may be expressed as a number between zero (0) and one (1) (or a percentage from 0% to 100%), is directly proportional to the thermal radiation a material emits at a given wavelength. Similarly, reflectivity—the amount of energy reflected by a material at a given wavelength, may also be expressed as a number between zero (0) and one (1) (or a percentage from 0% to 100%) and is directly proportional thereto. For any given material at a given wavelength, emissivity and reflectivity sum to unity (i.e., one).

A radiant barrier is a material or combination of materials that functions to inhibit heat transfer by thermal radiation. Accordingly, radiant barriers exhibit high reflectivity and low emissivity at thermal wavelengths. Thus, typically one or both surfaces of a radiant barrier is (or is coated with) a highly reflective material that directs thermal radiation away from the barrier. For a given (thermal) wavelength, radiant barrier materials typically have a reflectivity of 0.9 or greater and a corresponding emissivity of 0.1 or lower. In order to function properly, a reflective surface of a radiant barrier should face an open space, such air or vacuum, through which thermal energy may radiate. Otherwise, heat may be transferred from the barrier to another contacted surface via another process, such as conduction.

A common configuration for radiant barriers is a highly reflective material, such as aluminum or stainless steel, applied to one or both surfaces of a sheet of substrate material. Such barriers are used in a number of environments, from the vacuum of space to a common residential attic. While the basic construction of a radiant barrier used in such varied environments may be similar, in humid environments, a radiant barrier may also necessarily incorporate a ventilation mechanism, such as perforations, to allow for passage of moisture through the materials.

With the growing popularity of “energy efficient” structures, radiant barriers have found frequent use in commercial and residential buildings as a means of augmenting traditional insulation. However, many of the more common radiant barrier materials, such as aluminum foil, while low in cost may be easily damaged and/or are not aesthetically pleasing. For example, many commercially available radiant barrier materials are easily torn during and after installation, and said tears may, over time, lessen the effectiveness of the barrier. Therefore, a radiant barrier, and a method for manufacturing such, that combines the features of low cost, durability, aesthetically pleasing, and easy installation without damage to the barrier is desirable.

### SUMMARY

According to an exemplary embodiment of the present invention, a highly durable radiant barrier for inhibiting heat transfer by thermal radiation is provided. Such a radiant barrier may include a core material to which a reflective material is applied to one side, and a woven polyethylene sheet is applied to the opposite side. The core material ma be comprised of expanded polyethylene foam and a fire retardant material. The core material may also include layers of a mixture of low density polyethylene and a fire retardant material applied to either side of the expanded polyethylene core material. The reflective material may be polished aluminum foil and may include a number of holes penetrating into the core material. The woven polyethylene may be white (or any other aesthetically pleasing color) and have a smooth surface.

### BRIEF DESCRIPTION OF THE DRAWINGS

FIG. 1 is an isometric view of a radiant barrier according to an exemplary embodiment of the present invention.

FIG. 2 is a side view of a cross section of a portion of a radiant barrier according to an exemplary embodiment of the present invention.

### DETAILED DESCRIPTION

Embodiments of the present invention demonstrate a highly durable, long lasting radiant barrier insulation exhibiting good radiant performance with an aesthetically pleasing white, durable exposed surface on a side facing the occupied area of the structure. An expanded polyethylene (EPE) may be used as a core material. In certain embodiments, 3 mm EPE with a density of approximately 80 grams/m² may be used as the core material. The EPE material may be composed of 90% EPE with anti-static treatment, and 10% fire retardant material. In other embodiments, the core material may further comprise of a layer comprising about 90% low density polyethylene and about 10% fire retardant material applied to one or both sides of the EPE material. Further, the core material may be “cured” for a pre-determined number of days (dependant on local weather conditions such as temperature and humidity), and may be un-rolled and re-rolled backward half way through the curing timetable. EPE material is a recyclable, “environmentally-safe” material and is flexible, light, and exhibits favorable elasticity and resiliency. Fire retardant materials may be composed of Mg₂O₃ and Al₂O₃.

A highly reflective material, such as aluminum foil, may be applied to the core material. To achieve the desired radiant performance, embodiments of the present invention may use 7 micron polished aluminum foil with a density of approximately 19 grams per square meter and with a purity of at least 99.3%. Said aluminum foil may be applied on one surface of the core material. Approximately 55 to approximately 60 grams/m² white “woven” polyethylene (PE) may be applied on the opposite surface of the core material. The PE material may have a bright white, smooth, durable surface that is aesthetically pleasing and easy to maintain. Furthermore, certain embodiments of the present invention may receive a class A rating in the ASTM-84 test.

Certain embodiments of the present invention include a process for manufacturing a radiant barrier, which may include the steps of:
1. unrolling a sheet of expanded polyethylene foam such that it is kept flat and not stretched;
2. uniformly spraying a mixture of hot liquid containing about 90% low density polyethylene and about 10% fire retardant material composed of Mg₂O₃ and Al₂O₃ onto the expanded polyethylene foam at a rate of approximately 15 to approximately 20 grams/m²;
3. immediately applying about 55 to about 60 grams/m² woven polyethylene to one surface of the expanded polyethylene foam and 7 micron polished aluminum foil with a density of about 19 grams/m² to the opposite surface of the expanded polyethylene foam;
4. pressing the woven polyethylene, expanded polyethylene foam, and 7 micron polished aluminum foil together between two rollers;
5. punching a series of approximately 3 mm in diameter holes into the aluminum foil in a random pattern, the holes penetrating through the aluminum foil and into the expanded polyethylene foam but not into the woven polyethylene;
6. cutting the roll to a desired width and length.
   The expanded polyethylene foam referenced in step 1 above may be comprised of about 10% flame retardant material composed of a mixture of Mg₂O₃ and Al₂O₃ and about 90% low density polyethylene. The resulting final product is extremely rugged and resilient, allowing installers to handle the product quickly and easily without tearing or damage. Accordingly, the end user may receive a quality installation and a long lasting energy efficient structure with an aesthetically pleasing interior surface. The emissivity of the final product may range from about 0.05 to about 0.07.

Like reference characters denote like parts in the drawings.

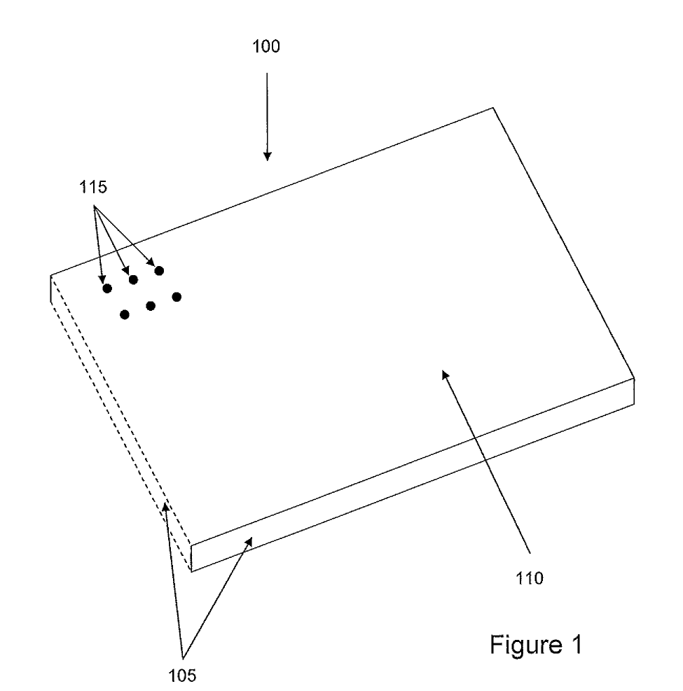

FIG. 1 illustrates an isometric view of a radiant barrier 100 according to an embodiment of the present invention. Core material 105 may be comprised of expanded polyethylene (EPE) material which, in some embodiments, may be composed of about 90% EPE with anti-static treatment and about 10% fire retardant material and measure about 3 mm wide. In other embodiments, core material 105 may further comprise a layer of about 90% low density polyethylene and about 10% fire retardant material applied to one or both sides of the EPE material. Reflective material 110 is applied to one side of radiant barrier 100. Reflective material 110 may be comprised of any appropriate reflective material, such as aluminum or stainless steel. In certain embodiments, reflective material 110 may be comprised of polished aluminum foil. In further embodiments, the polished aluminum foil may be 7 micron polished aluminum foil having a density of approximately 19 grams/m² and a purity of at least 99.3%. In some embodiments, reflective material 110 may include one or more holes 115, said hole or holes 115 penetrating through reflective material 110 and into core material 105. The side (not shown) of radiant barrier 100 opposite reflective material 110 may include a layer of polyethylene which, in certain embodiments, may be white in color and/or have a smooth surface. In other embodiments, said layer may be comprised of any such durable, aesthetically pleasing material.

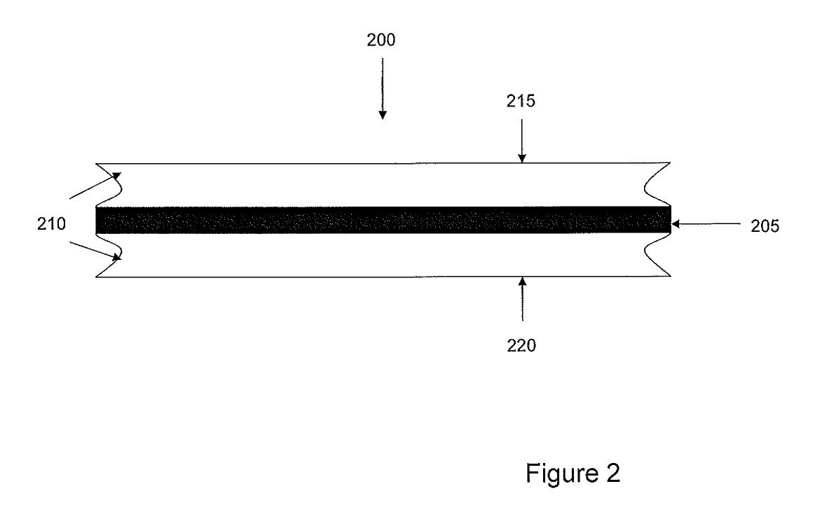

FIG. 2 illustrates a side view of a cross section of a portion of a radiant barrier according to an embodiment of the present invention. In this embodiment of the present invention, the core material is comprised of an expanded polyethylene (EPE) layer 205 onto which a low density polyethylene layer 210 has been applied on each side. EPE layer 205 may be composed of about 90% EPE with anti-static treatment and about 10% fire retardant material and, in some embodiments, may measure about 3 mm wide. Low density polyethylene layers 210 may be comprised of about 90% low density polyethylene and about 10% fire retardant material applied to one or both sides of the EPE material. In some embodiments, low density polyethylene layers 210 may be applied to EPE layer 205 by spraying layers 210 in liquid form at about 15 to about 20 gams/m². Reflective material 215 may be applied to one side of radiant barrier 200, and interior layer 220 applied to the opposite side of radiant barrier 200. Interior layer 220 may be configured to be both durable and aesthetically pleasing, as interior layer 220 may face the interior of a structure into which radiant barrier 200 is installed. In some embodiments, interior layer 220 may be comprised of white “woven” polyethylene having a white, smooth, and/or durable surface. In further embodiments, said white “woven” polyethylene may be about 55 to about 60 grams/m².

While the embodiments are described with reference to various implementations and exploitations, it will be understood that these embodiments are illustrative and that the scope of the inventions is not limited to them. Many variations, modifications, additions, and improvements are possible. Further still, any steps described herein may be carried out in any desired order, and any desired steps may be added or deleted.

What is claimed is:

1. A radiant barrier, comprising:
a core layer including expanded polyethylene and a fire retardant material;
a polished aluminum foil; and
a woven polyethylene;
wherein the polished aluminum foil is applied to one side of the core layer, and the woven polyethylene is applied to the opposite side of the core layer.

2. The radiant barrier of claim 1, wherein the core layer includes about 90% expanded polyethylene and about 10% fire retardant material.

3. The radiant barrier of claim 2, wherein the fire retardant material includes Mg₂O₃ and Al₂O₃.

4. The radiant barrier of claim 3, wherein the core layer has a thickness of about 3 mm.

5. The radiant barrier of claim 4, wherein the core layer has a density of about 80 grams/m².

6. The radiant barrier of claim 1, wherein the polished aluminum foil has a purity of at least 99.3%.

7. The radiant barrier of claim 6, wherein the polished aluminum foil has a density of about 19 grams/m².

8. The radiant barrier of claim 1, wherein the woven polyethylene is white.

9. The radiant barrier of claim 1, wherein the woven polyethylene has a density of about 55 to about 60 grams/m².

10. The radiant barrier of claim 1, further comprising a plurality of holes is punched into the aluminum foil, wherein said holes penetrate into the core layer.

11. The radiant barrier of claim 10, wherein each of the plurality of holes has a diameter of about 3 mm.

12. The radiant barrier of claim 11, wherein the holes are punched in a random approximate 3 cm by 3 cm pattern.

13. The radiant barrier of claim 1, further comprising a second and third core layer, each of the second and third core layers including low density polyethylene and a second fire retardant material, wherein the second core layer is situated between the first core layer and the polished aluminum foil, and the third core layer is situated between the first core layer and the woven polyethylene.

14. The radiant barrier of claim 13, wherein each of the second and third core layers includes about 90% low density polyethylene and about 10% fire retardant material.

15. The radiant barrier of claim 14, wherein the second fire retardant material includes Mg₂O₃ and Al₂O₃.

16. The radiant barrier of claim 15, wherein each of the second and third core layers has a density of about 15 to about 20 grams/m².

17. A method for creating a radiant barrier, comprising the steps of:
a. providing a sheet of expanded polyethylene foam having two sides;
b. applying a liquid solution including low density polyethylene and a fire retardant material onto the first and second sides of the expanded polyethylene foam;
b. applying a sheet of woven polyethylene to the first side of the expanded polyethylene foam atop the liquid solution;
c. applying a sheet of polished aluminum foil to the second side of the expanded polyethylene foam atop the liquid solution;
d. pressing the woven polyethylene, liquid solution, expanded polyethylene foam, and polished aluminum foil together to form a radiant barrier;
e. forming a plurality of holes into the polished aluminum foil such that each of said plurality of holes penetrate through the polished aluminum foil into the expanded polyethylene foam; and
f. cutting the radiant barrier to a desired width and length.

18. The method of claim 17, wherein the expanded polyethylene foam includes about 90% expanded polyethylene foam and about 10% fire retardant material.

19. The method of claim 18, wherein the fire retardant material includes Mg₂O₃ and Al₂O₃.

20. The method of claim 19, wherein the expanded polyethylene foam has a thickness of about 3 mm.

21. The method of claim 20, wherein the expanded polyethylene foam has a density of about 80 grams/m².

22. The method of claim 17, wherein the liquid solution includes about 90% low density polyethylene and about 10% fire retardant material.

23. The method of claim 22, wherein the fire retardant material includes Mg₂O₃ and Al₂O₃.

24. The method of claim 23, wherein the liquid solution is applied to the first and second sides of the expanded polyethylene foam at a density of about 15 to about 20 grams/m².

25. The method of claim 17, wherein the wherein the polished aluminum foil has a purity of at least 99.3%.

26. The method of claim 25, wherein the polished aluminum foil has a density of about 19 grams/m².

27. The method of claim 17, wherein the woven polyethylene is white.

28. The method of claim 17, wherein the woven polyethylene has a density of about 55 to about 60 grams/m².
